(19) United States
(12) Patent Application Publication
(10) Pub. No.: US 2012/0300134 A1
(43) Pub. Date: Nov. 29, 2012

(54) REMOTE CONTROL OPERABLE STANDS FOR TV DISPLAY

(76) Inventors: Christopher SLOWINSKI, Great Neck, NY (US); Wieslaw BOBER, Astoria, NY (US); Krzysztof KAZANA, Krakow (PL); Hugo SZARANIEC, Krakow (PL); Andrzej POLAK, Zielonki (PL); Kamil SIENKIEL, Ostrowiec Swietokrzyski (PL)

(21) Appl. No.: 13/440,646

(22) Filed: Apr. 5, 2012

Related U.S. Application Data
(60) Provisional application No. 61/472,446, filed on Apr. 6, 2011.

(51) Int. Cl. H04N 5/44

(52) U.S. Cl. 348/734; 348/E05.096

(57) ABSTRACT

A rotary stand for TV screen or monitor, which require an adjustable angular position relative to its vertical axis, secured in a holder in a bearing column, mounted rotationally in a fixed mount, fitted with a controlled electric drive of the bearing column bi-directional rotation and a potentiometer for electric adjustment of the bearing column angular position is described together with a support stand that is mountable to a lateral wall. The stand has a programmable control system enabling the limit angular positions of the screen secured in the holder on the bearing column to be automatically set and programmed. A remote control for controlling the rotation of the TV monitor and an LED lighting strip for showing the position of the TV monitor selected and a direction of movement of the TV monitor are also provided.

### CROSS-REFERENCE TO RELATED APPLICATIONS

The present application claims priority of U.S. Provisional Patent Application Ser. No. 61,472,446, filed Apr. 6, 2011, which in turn incorporates by reference U.S. Provisional Patent Application Ser. No. 61/460,804, filed Jan. 7, 2011, the entire contents of which are hereby incorporated in full by reference.

### FIELD OF THE INVENTION

The present invention relates to the fields of television and display stands and mounts that can be secured to a piece of furniture or a wall and a remote control unit for controlling the stand, including a rotation of the stand.

### BACKGROUND OF THE INVENTION

Stands for display devices and multi-media equipment, and remote control devices for controlling the stands, are provided, for example, for stands for flat screen televisions, audio equipment, and various multimedia components (e.g., BLU-RAY devices, DVD devices, CD audio devices) as well as from devices providing Internet-based content, such as for audio and video streaming sites (e.g., PANDORA.COM and YOUTUBE.COM).

Rotating a TV screen or monitor, with an angle of rotation testing system are known. Solutions fitted with this function use various external sensors for adjusting the set angular position, for instance magnetic or induction sensors. However these solutions are not particularly flexible and do not ensure a sufficient accuracy of the angle of rotation adjustment for the viewer. At the same time potentiometric systems for measuring the angle of rotation of a moving member are known.

A potentiometer for measurement the angle of rotation of a shaft compared with a fixed member is known from U.S. Pat. No. 5,113,172. The potentiometer has two resistance paths situated concentrically on a fixed disk. On the second disk, seated in parallel to the fixed disc and rotating together with a shaft, two collector paths are mounted as concentric circular paths. Two brushes of the collector paths contact slideably the resistant paths. The measurement signal is obtained from contacts situated on the fixed disc and connected to the resistance paths.

A device for rotating a TV screen with the adjustment of the angle of rotation using a potentiometer driven by an electric motor and a couple of permanently meshed gear wheels as a control and measurement component is known from US/2006/0284034. A solution like this provides freedom to adjust the screen angle of rotation, however due to the use of intermediary gear wheels and plays in the toothed gear it has little precision. For wide screens, even a small difference in the angle of rotation causes a substantial shift of the screen edge. The device is fitted with a control system enabling the rotation to be stopped once the set angle of rotation of the screen relative to its vertical axis has been reached, as read from the potentiometer signal. The set angle is stored in the memory system.

Also mounts for seating a monitor or TV screen at a distance from a wall or in a piece of furniture are known. In these solutions the support is a plate, on which a fastening member is seated, fitted with a plate or two arms secured to the rear wall of the screen.

Remote controls for controlling televisions are well known, however a person may wish to control exact positioning of the television screen, monitor or display using a remote control that is a universal remote control or handheld device that has other functions, and the user may wish to avoid fumbling with the positioning of the display.

Features and advantages of the present application will become apparent from the following description of the invention that refers to the accompanying drawings.

### SUMMARY OF THE INVENTION

An object of the invention is to introduce a screen stand allowing precise control, with accuracy to a half degree, of the rotary movement of the bearing column actuated by an electric drive.

An object of the invention is to provide a rotary stand for a TV screen or monitor such that the angular position of the TV screen is adjustable relative to its vertical axis, and the TV is secured in a holder on a vertical carrying column, mounted rotationally in a stationary mount, fitted with a controlled electric drive of bi-directional rotary movement of the carrying column.

Also disclosed is a remote control device that allows the user to turn or to rotate the TV display using the stand to previously set turning positions and to provide visual feedback to the user as to the current position of the TV monitor or as to the position of the TV monitor to which it is being set, and as to a direction of the turning of the TV monitor. A visual feedback of the position and the direction of movement may include an LED lighting ring positioned around the column of the stand.

An automatic control system using a potentiometer, directly, concentrically coupled with the bearing column, to adjust the angular position of the screen, which is secured with a holder on the bearing column and a friction clutch, being a component of a kinematic chain transferring the torque from the electric drive to the bearing column. The power unit transferring the torque consists of the electric drive turning the bearing column with the friction clutch and the main gear, whose driven wheel is concentrically, permanently seated on the bearing column and constitutes its drive. The bearing column is rotationally seated, advantageously in a position perpendicular to the mount plane, on a fixed mount.

A significant feature of the invention is also a programmable microprocessor control system enabling the limit angular positions of the screen secured in the holder on the bearing column to be automatically set and programmed.

The complete potentiometer comprises a ring, directly coupled with the rotary bearing column, on which a slide is fixed, and a disk with concentrically situated ring-shaped resistance paths. The slide rotates together with the bearing column, at the same time sliding on the resistance path on the disk. The angular position of the bearing column is read by the potentiometer by measuring the voltage level on the resistance path. The design features of the potentiometer enable it to controllably turn up to 320 degrees. The measurement is interpreted by an internal microprocessor system, which then controls, in accordance with the software algorithm, the operation of the positioning power unit. This sort of design allows the device position angle to be set with the accuracy up to ½-1 degree, eliminating errors in angle measurement in the device mechanical system, which is unattainable in the existing solutions.

The control system software enables the limit angular positions of the screen secured in the holder on the bearing column to be automatically set and stored. The signal that shuts the power unit off is the recorded slide of the friction clutch, therefore it is essential that the maximum torque transferred by the friction clutch be correctly pre-set. This setting depends most of all on the foreseen weight of the screen.

Stopping of the drive resulting from a friction clutch slide is a signal to the control system, actuating the reverse movement of the bearing column by the set angle value. Next, the control system may store this position in its non-volatile memory.

A solution like this has many operating advantages. Among others the self-programming of limit angular positions of the screen resulting from the close distance between the screen and the wall is possible. In addition, this solution protects the screen and the stand against damage when other accidental items happen to be in the way of the turning screen.

The control system also enables selected screen angular positions to be pre-programmed. The control system may be programmed according to several known methods. The most convenient programming method for the proposed device is remote wireless programming or in some potential applications remote programming via a wired connection. When an operator has convenient access to the stand, the programming panel may be directly incorporated in the stand body.

Another object of the invention is to provide a support for a TV screen or monitor secured in the holder on the vertical carrying column, mounted rotationally, moved by the bidirectional rotary movement electric drive or manually.

A versatile mount is provided to enable an electrically or manually driven screen to be mounted on any plate or directly on a furniture wall.

A support according to the invention consists of a vertical stand and a horizontal fastening member. Accordingly, the screen support is a spatial angular support comprising at least two walls situated vertical to the base plane, connected at first ends to the stand holder and at the other ends—to a lateral wall setting the fastening plane situated perpendicularly to the base plane. The support walls have a spatial framework construction with ribs. The lateral wall may have also a spatial framework construction with ribs.

The angular support cross-section has an “L” shape in the fastening position with the horizontal leg longer and the vertical leg shorter. The lateral wall has means for fastening the support to the fastening plane. In the holder a rotary stand is mounted with a controlled electric drive of bi-directional rotary movement of the carrying column, seated rotationally against the stationary support, perpendicularly to the base plane.

An electronic module is placed between the support walls. A recorder and player socket is situated in the electronic module cover.

The advantage of the solution according to this aspect of the invention is the stability of the support and safe holding of a TV set by it. At the same time the simple design of the support facilitates its mounting and restraining in the base. The angular support enables the TV set to be secured to plates of various sizes and directly to the furniture. A compact design and wires hidden inside the support provide its functional and aesthetic values.

Other features and advantages of the present invention will become apparent from the following description of the invention, which refers to the accompanying drawings.

### BRIEF DESCRIPTION OF THE DRAWINGS

For the purpose of illustrating the invention, there is shown in the drawings several forms which are presently preferred, it being understood, however, that the invention is not limited to the precise arrangements and instrumentalities shown. The features and advantages of the present invention will become apparent from the following description of the invention that refers to the accompanying drawings, in which:

The solution according to the invention is presented in the embodiments in the drawings, where the individual figures present:

FIG. 1 illustrates rotary stand in an exploded view;

FIG. 2 illustrates electric drive and the friction clutch assembly in an exploded view;

FIG. 3 illustrates potentiometer components put on the bearing column in a perspective view;

FIG. 4 illustrates examples of potential angular positions of the device;

FIG. 5 illustrates a diagram showing the method of self-programming of the limit positions of the device;

FIG. 6 illustrates a diagram showing a reaction of the device to a barrier;

FIG. 7 illustrates a diagram showing the kinematic drive chain and control;

FIG. 8 illustrates the support in an exploded view;

FIG. 9 illustrates the support in an exploded view, with the electronic module shown;

FIG. 10 illustrates a TV set seated on the support, in a perspective view from the front;

FIG. 11 illustrates a TV set seated on the support, in a perspective view from the back;

FIG. 12 illustrates a stand with an extension piece;

FIG. 13 illustrates a receiving mechanism for mounting the stand;

FIG. 14 illustrates a rubber clamp;

FIG. 15 illustrates a furniture mounting a support;

FIG. 16 illustrates a perspective view of the furniture mounting support for glass;

FIG. 17 illustrates a support for mounting to a wall;

FIG. 18 illustrates a control panel with volume buttons and IR receiver eye;

FIG. 19 illustrates the stand with lighting ring;

FIG. 20 illustrates the TV stand with the rotation device.

FIG. 21 illustrates an automated entertainment center diagram and a remote control device identifying principles of operation in accordance with an embodiment.

FIG. 22 illustrates an example of an automated entertainment center design and external components in accordance with an embodiment.

FIG. 23 illustrates a portion of a TV supported by a TV stand with a lighting ring.

### DETAILED DESCRIPTION OF EMBODIMENTS OF THE INVENTION

In accordance with one aspect of the present application, an automated entertainment center (also referred to and shown in the drawings as “multimedia furniture”) comprising furniture is configured for supporting a television and at least one electric drive and electronic drivers for one or more of automatic opening of a drawer, operating controls for supporting the television (e.g., rotation, extension, tilt, or the like), internal ventilation, lighting and security, which may be in the form of thermal sensors or other suitable technology.

In an embodiment, the automated entertainment center is configured with a transmission/reception device for reception and/or transmission of one or more kinds of signals, such as infrared (“IR”) signals. In an embodiment, an IR sensor receiver/transmitter receives IR signals from a device, such as a remote control infrared sending unit, and uses the received signals to transmit IR signals to one or more respective devices that may be configured with the automated entertainment center or provided in the automated entertainment center (such as audio/video equipment). Therefore and in an embodiment, the automated entertainment center includes a transmitter to control a plurality of devices provided with or in the furniture.

In addition to infrared signals, devices transmitting in other signal formats and communication protocols are supported by the teachings herein. For example, the automated entertainment center according to the present application may include a Wi-Fi transceiver to be integrated in a WI-FI network or other local area network, which enable instructions to be sent and received, for example, over the Internet or other communication network. In an embodiment, the automated entertainment center is configured with one or more communications devices for, for example, TCP/IP, 3G or 4 G communications, or other suitable protocol. Messages may be sent to and/or received from a computing device, such as a server, for operating or otherwise controlling the respective devices provided with or in the automated entertainment center. Moreover, one or more processors are provided for processing commands received therein.

Instructions that are received over a communication network, such as the Internet, may be used by the transmission/reception device configured with the automated entertainment center to control the respective devices that are configured with or included in the automated entertainment center. In addition to WI-FI, instructions may be transmitted via BLUETOOTH or other protocol by a user using a cellular telephone or other portable device. In an embodiment, a Wi-Fi- to IR bridge is provided, and instructions are translated from one communications protocol format to another. For example, instructions are transmitted in TCP/IP packets, and are received by a server over the Internet. The server transmits the same or other packets associated with the TCP/IP packets to the transmission/reception device provided with the automated entertainment center. Once received, the packets are examined and the instructions therein are translated to IR signals, which are transmitted to one or more devices configured with or included in the automated entertainment center. Thus, a plurality of communication protocols and signal types are supported in accordance with the teachings herein.

In a preferred embodiment, the transmission/reception device is configured to copy and remember infrared codes that are issued by one or more infrared remote control units and that apply to one or more of a plurality of devices configured with or included in the automated entertainment center. A plurality of respective infrared remote controls for various devices (e.g., television, amplifier, BLU-RAY player, or the like) are supported and the transmission/reception device configured with the automated entertainment center copies and remembers the codes of the respective devices. For example, every signal sent by a respective remote control unit is remembered and used for control of a respective device.

In an embodiment, a single and customizable remote control unit is provided and used for controlling one or more of each of the respective devices that are configured with or included in the automated entertainment center. The customizable remote control unit may be configured in any of a plurality of ways, such as with a keyboard, touch-screen, voice recognition or user input element. The customizable remote control unit can be programmed or configured by a user for coding functionality for the respective devices.

In an embodiment, codes for all of the respective devices configured with or included in the automated entertainment center are copied to the transmission/reception device for controlling the devices. In an embodiment, a keyboard or other input is configured with the transmission/reception device, and respective infrared codes for each of the devices configured with or included in the automated entertainment center are associated with the respective buttons of the keyboard or other input. A user can use the keyboard or other input provided with the transmission/reception device to control operations of the television or other device.

Moreover, codes of the respective devices that are saved in a memory, such as in a control unit of the transmission/reception device, may be transmitted via the transmission/reception device to the customizable remote control for operating the automated entertainment center. Preferably, the transferring of the codes from the transmission/reception device to the customizable remote control unit causes the remote control unit to substantially mimic the keyboard or other input of the transmission/reception device. For example, the button arrangements and controls of the customizable remote control unit are configured in the same relative positions of the particular remote control unit as the control keyboard provided with the transmission/reception device of the automated entertainment center.

In an embodiment, the customizable remote control unit configured with a mechanical keyboard having a plurality of keys or buttons. In a preferred embodiment, after codes of all devices configured with or included in the automated entertainment center are transferred from the transmission/reception device of the automated entertainment center to the remote control unit, only those buttons that control the units will be active. In an alternative embodiment, that uses a touch pad in lieu of a keyboard, graphical buttons or other icons are for particular devices that are configured with or included in the automated entertainment center will be displayed and active. In this alternative embodiment, a user interface is supported whereby the touch pad provides for adding one or more graphical controls, which may include a respective description of the function of the active icons.

For example, a user presses a key combination, such as 123 or clicks on a particular graphical icon that represents a particular device in order to transmit a signal to transmission/reception device of the automated entertainment center and to control operations of a respective device included with or in the automated entertainment center.

In an embodiment, a software application such as for an IPOD, IPAD, ANDROID or other portable device, is provided for enabling remote control operations of one or more devices configured with or included in the automated entertainment center. For example, a user downloads an IPHONE application from the APPLE APP STORE and installs the application on his IPHONE. The user starts the application and, depending upon the communication protocol that is in use, such as WI-FI, BLUETOOTH, cellular telephone or other network, the IPHONE application is trained with information regarding the respective devices that are configured with or included in the automated entertainment center. In an embodiment, after the transmission/reception device of the automated entertainment center is configured and instructed as to the respective devices configured with or included in the automated entertainment center, information is transmitted to a computing device over the Internet about those respective devices. When the APP is configured on the user's IPHONE, information is transmitted from that computing device to the IPHONE application about the particular devices. In this way, the IPHONE application configures the IPHONE to operate as a remote control device for operating the devices configured with or included in the automated entertainment center. Thereafter, when a user uses the IPHONE application, the user simply selects the respective device in the automated entertainment center the user wishes to control and using one or more graphical screen controls, e.g., sliders, buttons, switches, drop down lists or the like, controls the operations of the devices.

Therefore, in accordance with the teachings herein, a plurality of communication protocols (e.g., IR, TCP-IP, BLUETOOTH, 3G, 4G or the like) are supported and usable by the transmission/reception device of the automated entertainment center for controlling the various devices provided therein.

In an embodiment, the automated entertainment center is configured with an automatic detection system for detecting damage of one or more peripheral units. The automated entertainment center may also be configured to automatically monitor the devices, and to send one or more messages over a communication network alerting a user to damage detected by the entertainment center.

In one embodiment, the automated entertainment center is configured with one or more exterior cameras and/or intercoms to enable communication with someone outside of a home. As a person arrives at a house, for example, the television configured in the automated entertainment center displays an image of the person as seen by the exterior camera. Thus, a form of a home or building security system is provided in accordance with the teachings herein.

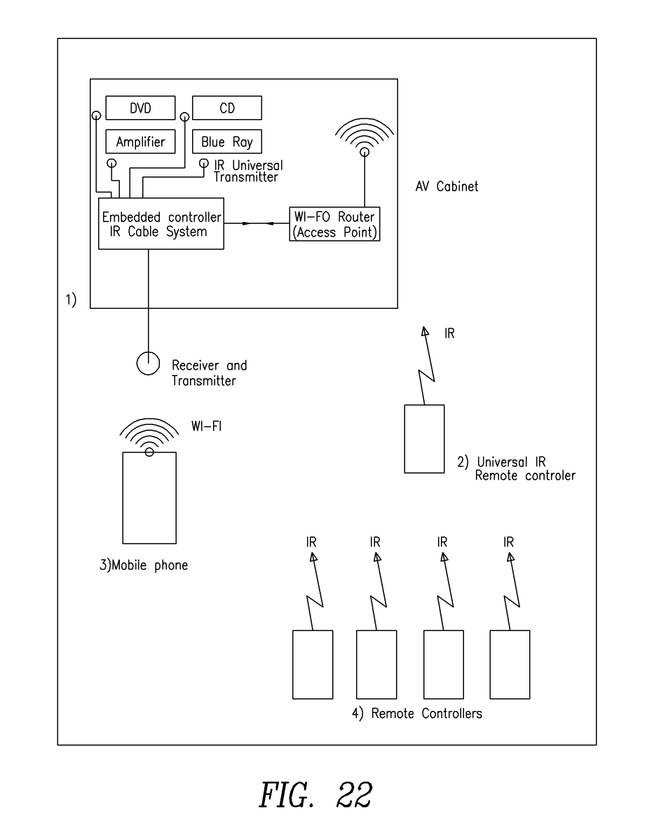

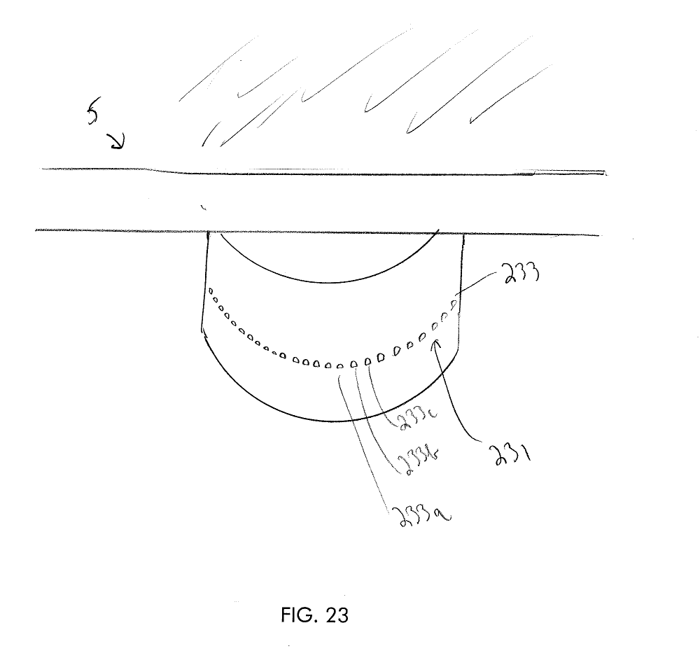

In addition, according to an embodiment of the present invention, a computer server can be built into the stand or provided at the stand to control positioning of the television screen and to provide a current position information of the display to the remote control device. For example, the computer server built into the stand can communicate directly with a remote control device to provide position information for the LED screen. By way of illustration with reference to FIG. 21, a remote control device button L1 may be lit up in the remote control unit to show that the stand has rotated the TV display currently to a position corresponding to the L1 preset, which may be positioned just to the left of the dead center position of the TV display. A computer server may communicate directly with a remote control device, for example, using Bluetooth technology or may provide signals to a wireless router positioned in the vicinity, or may be in communication with remote control unit via the internet, such that the computer server of the stand is connected by wire or wireless means to a modem, such as a broadband modem connected by a coaxial cable, while the remote control device may be connected via a wireless link to a wireless router positioned in the vicinity of the remote control unit. Remote control device can communicate directly with the server or indirectly as described herein to control the functionality of the stand and the lighting associated with the stand.

In addition, remote control can activate the rotation of the stand to turn the TV left or right as desired by the user. A number of presets may also be provided to turn the TV to these previously set positions of the stand. For example, there may be a center position, C, at which the television faces forward and not rotated left or right, an L1 position at which the display is turned slightly to the left hand side of a person watching, an L2 position at which the display is turned more to the left than at L1, and an L3 position at which the display is turned as far to the left as is practical for the particular arrangement of the stand and the television. Similarly, R1, R2 and R3 positions may be provided to turn the display from the C position in a rightward turn with respect to the right hand of a person watching the display. More than three or fewer than three left and right positions may also be provided.

Each of these preset positions, C, L1, L2, L3, R1, R2, R3 may be provided as buttons, either mechanical buttons or as “soft” buttons on a virtual display pad or touch pad, of the remote control device. To facilitate pivoting of the display by a person using a remote control, each of these presets may be provided directly as a button or control on the remote control. FIG. 22 illustrates a remote control with buttons C, L1, L2, L3, R1, R2 and R3.

Also, contemplated according to another aspect of the present invention is an LED lighting ring 231 comprising a number of LED lights 233 mounted on the stand that supports and rotates the television display 5 above. Although described as an LED light 233, each light may be comprised of a number of LEDs, or may be provided as other types of lighting, such as LCDs, halogen lamp, fluorescent or compact fluorescent lights or the like.

In response to a turn command from the remote control, LED ring 231 can provide an indication of the direction of the turning. For example, LED lights 233 can light up in sequence shortly following one another in a direction in which the turning operation has been selected. Thus, LED light 233b can be lit briefly followed quickly in succession by LED light 233c and so on toward the right hand side of LED ring 231 to signal that the display is being turned toward the right hand side of the user watching. Similarly, LED lights 233 can be lit up briefly in sequence in the opposite direction when the TV display is being turned left. In the alternative, all LED lights 233 on the right of the centrally positioned LED light 233a may turn on or may flash on and off when turning toward the right of the user has been selected and all the LED lights 233 to the left of the central light 233a may be lit or may flash to signal that the display has been selected to turn left.

Also, different colored LED lights may be provided as part of the same LED light 233 and different colors may be displayed to indicate that the display is turning in the direction of the lights. For example, blue lights at LED lights 233 on the right side of the stand may indicate that the television display is being turned toward that direction, while remaining LED lights 233 of LED ring 231 remain white or some other color.

In addition, lighting ring 231 may also show the position of the display. Thus, for example, all lights 233 of the LED light ring 231 may be on to indicate that the television display 5 is stationary or all be off to indicate that it is stationary, and various lights 233 may be turned on to show when the television display is moving. Thus, when the television display is stationary all lights of lighting ring 231 may be on, and when a new display position has been selected, for example when a previously set display position L1 has been selected, LED light 233 corresponding to a dead center frontal light for that display position may flash or may be turned on while the remaining lights are turned off or are turned on to indicate the direction of movement.

For example, if L1 indicates a left preset position in which the display will be perpendicular exactly to a position at which LED light 233c is in the dead center then, when L1 is selected at the remote control, all lights will turn off except for LED light 233c or all lights may be turned on in sequence as explained above to show the rightward turning movement of the display. Thus, the steady on position of LED light 233c will show the new position to which the television display is turning while the sequential turning on one after another in the right hand direction of LED light 233 of LED lighting ring 231 would indicate the right word turning of the display. In addition, in this situation, the new position LED light 233c may be shown as one color while the LED lights 233 showing the direction of the movement may be shown as another.

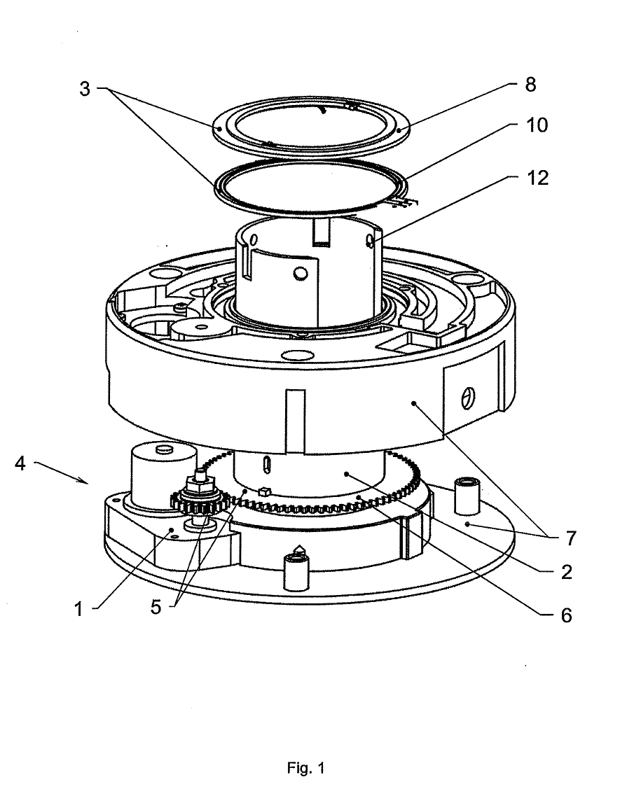

According to an embodiment, the rotary stand of a TV or monitor screen according to the invention, shown in FIG. 1 with a controlled electric drive 1 of bi-directional rotation of a bearing column 2 is fitted with a potentiometer 3 for electric adjustment of the angular position of the bearing column 2. The controlled rotation of the stand bearing column 2 is forced with the power unit 4, comprising:

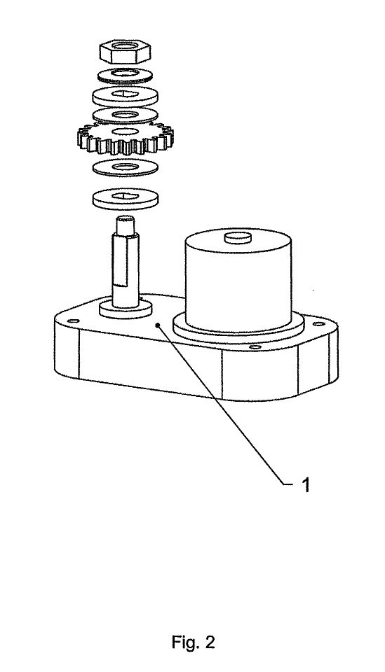

an electric drive 1, shown in FIG. 2,

a friction clutch, not shown in the drawing, which is integrated in one casing with the electric drive 1,

a main toothed gear 5, whose driven wheel is concentrically permanently seated on the bearing column and constitutes its drive.

The bearing column 2 is rotationally seated in a fixed mount 7, in a position perpendicular to the mount plane 7.

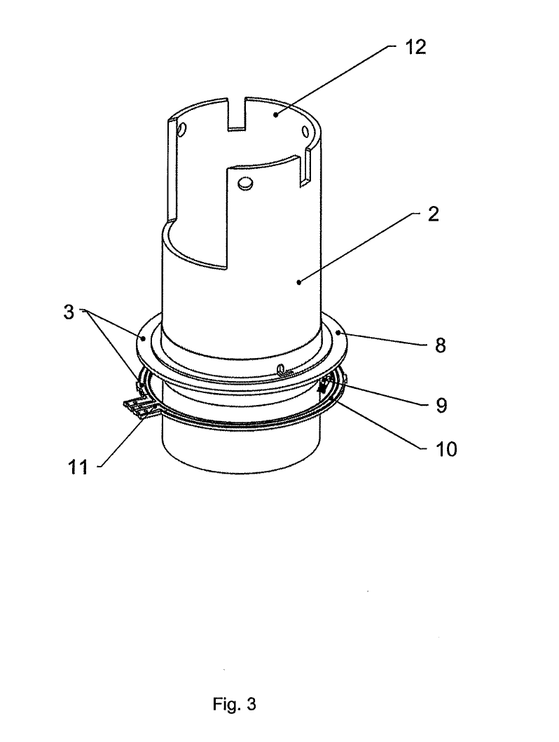

The main component of the bearing column 2 position angle adjustment system is a potentiometer 3, seen in FIG. 3, which is directly coupled to the bearing column 2.

The complete potentiometer comprises a ring 8, on which a slide 9 is fixed, stationary mounted on the bearing column 2, and a disk 10 with concentrically situated ring-shaped resistance paths 11. The slide 9 rotates together with the bearing column 2, at the same time sliding on the resistance paths 11 on the disk 10. The angular position of the bearing column 2 is read by the potentiometer 3 by measuring the voltage level between the end contacts of the resistance paths 11. The design features of the potentiometer 3 enable a controlled turn up to 320 degrees.

A change in voltage is read and interpreted by an embedded microprocessor system, not shown in the drawings, which next controls the operation of the positioning power unit 4. Design like this allows the position angle of the device to be read with the accuracy up to ½ degree, and to be set with the accuracy up to 1 degree, which is unattainable in the existing applied solutions.

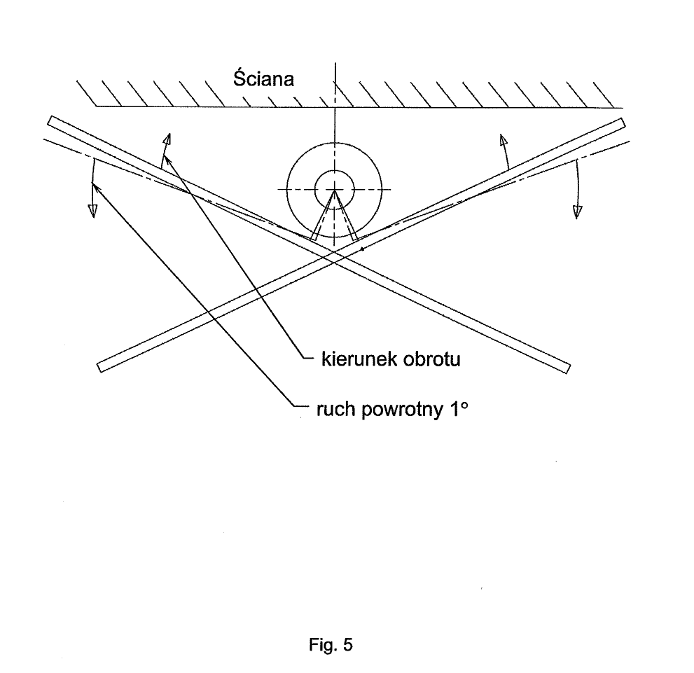

The control system software enables the limit angular positions of the screen secured in the holder 12 on the bearing column 2 to be automatically set and stored, which is diagrammatically shown in FIG. 5. A signal to switch the electric drive 1 off is the recorded slide of the friction clutch, resulting from the forced physical stop of the bearing column 2 rotation. A situation like this takes place when the screen rotation is blocked, e.g. by a wall or another barrier. While encountering a barrier, the device reads the value of potentiometer 3 voltage, which is invariable in time. At the same time the control system has the information about the continuous operation of the electric drive 1 and a slide of the friction clutch.

Stopping of the electric drive 1 by the programme, resulting from a reaction to the friction clutch slide, is a signal to the control system, actuating the reverse movement of the bearing column 2 by the set value of angle, advantageously around 1 degree. Next, the control system may store this position in its non-volatile memory. The reverse movement after stopping the rotation by a barrier is advantageous on account of safety of operations. It protects the system against repeatable contact of the screen edges with e.g. a wall, at each maximum angular displacement.

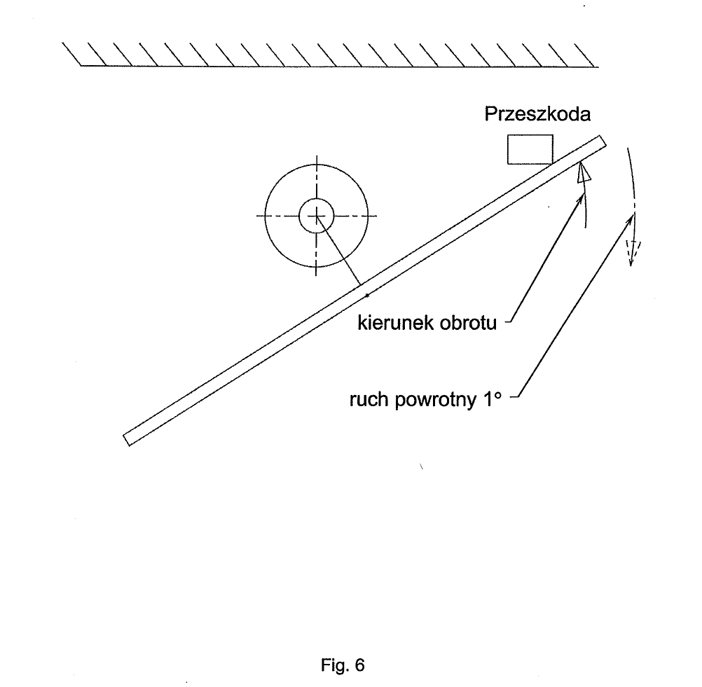

A solution like this has many operating advantages. Among others the self-programming of the limit angular positions of the screen resulting from the close distance between the screen and the wall is possible. In addition, this solution protects the screen and the rotary stand against damage when other accidental items happen to be in the way of the rotating screen. The described situation is presented in FIG. 6.

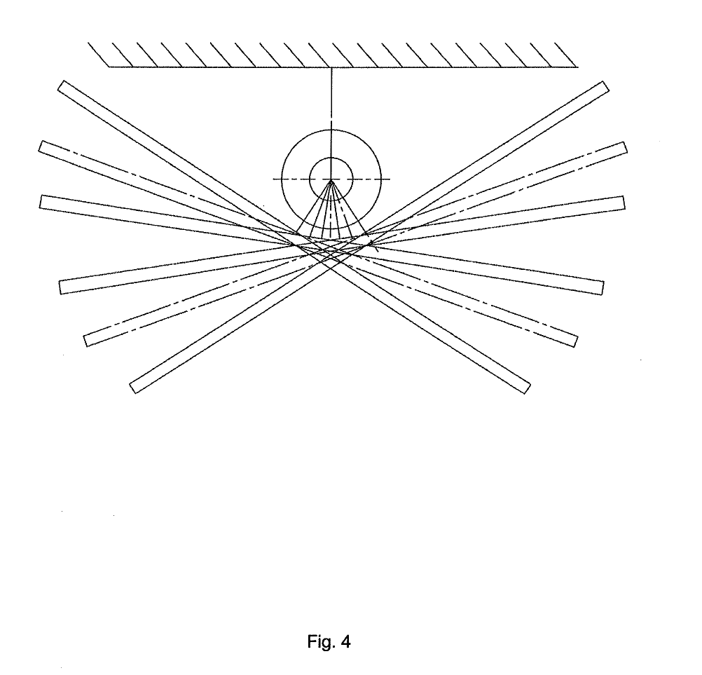

Also the control system enables selected screen angular positions to be pre-programmed. Example angular positions of the device are shown in FIG. 4.

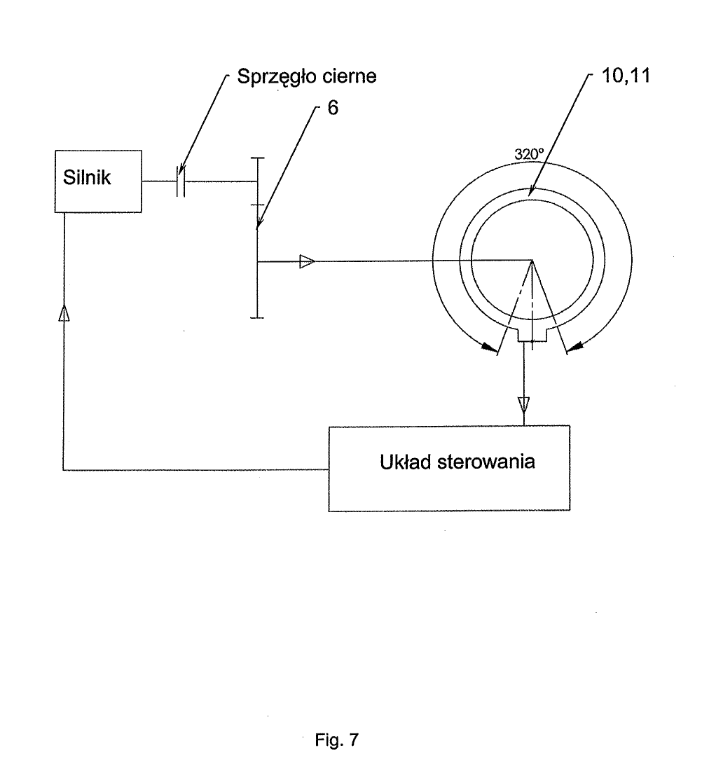

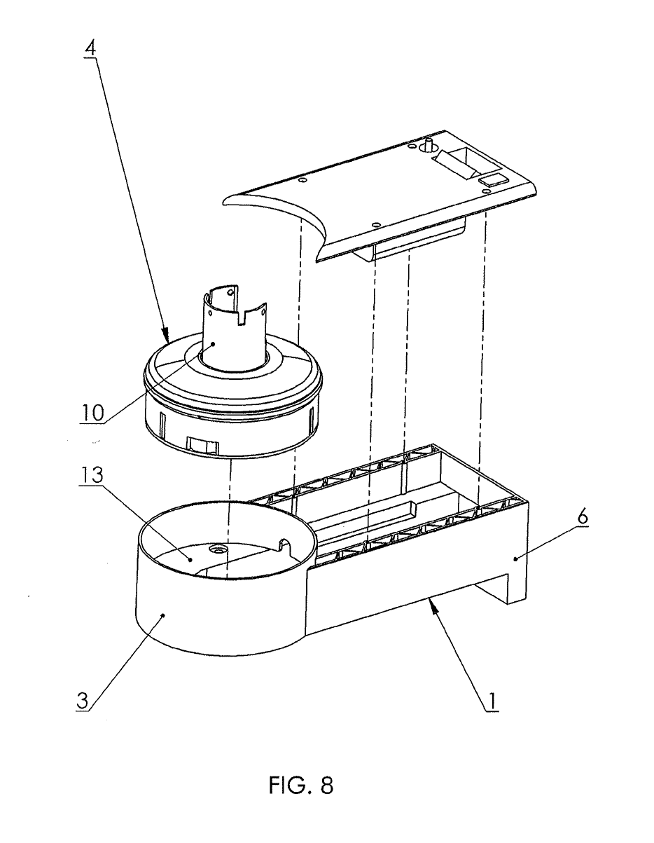

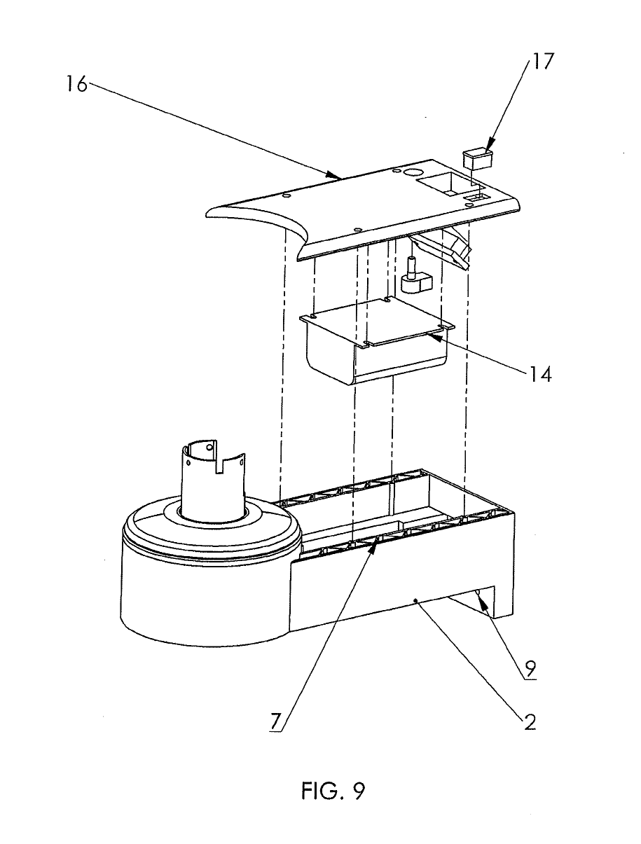

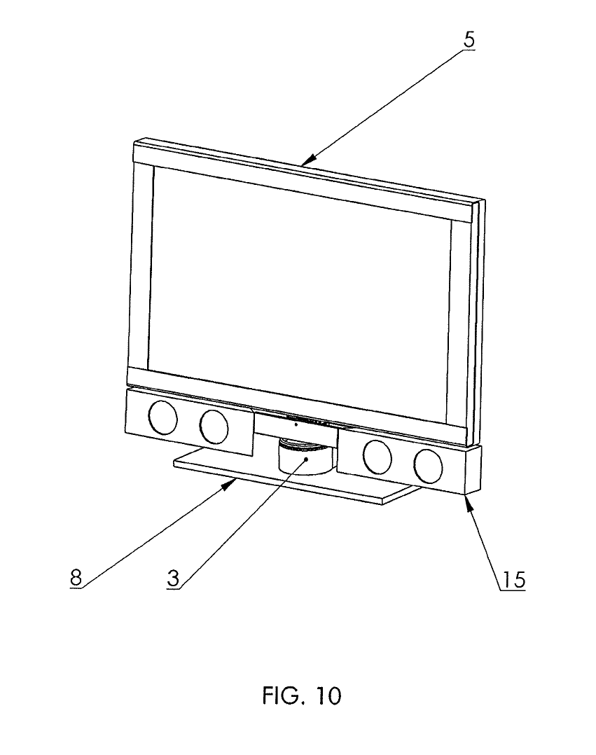

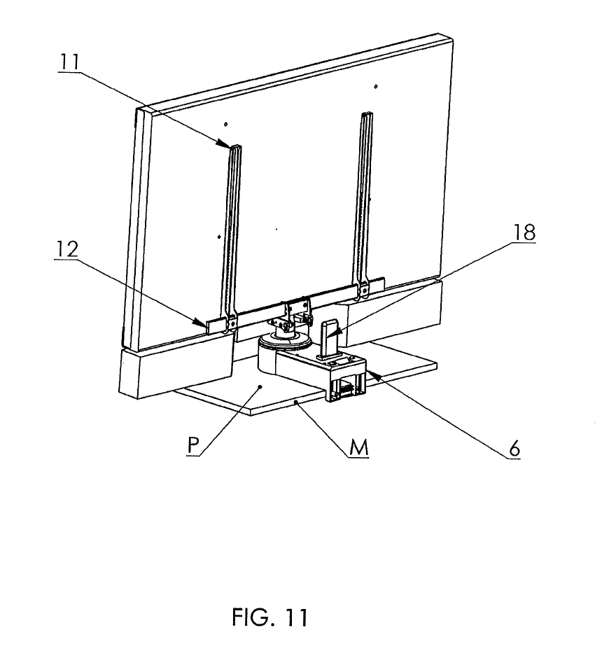

The control system, presented diagrammatically in FIG. 7 is programmable by a remote wireless device.

The support of a TV screen according to the invention is also provided. The support has the form of a spatial angular support 81 comprising two walls 82 situated vertically perpendicularly to the base P. The walls 82 are connected at first ends to the holder 83 of the stand 84 of the screen 85 and at the other ends—to the lateral wall 86. Therefore the angular support cross-section has an “L” shape in the fastening position with the horizontal leg longer and the vertical leg shorter. The support 81 walls 82 have a spatial framework construction and are fitted with bracing ribs 87. Also the lateral wall 86 may be a framework member with analogous ribs.

The lateral wall 86 is a member fastening the support, situated adjacent to the fastening plane M vertical to the base P. The base P plane is basically determined by a horizontal mounting plate 88 or a horizontal top wall of the piece of furniture, while the fastening plane M—by the vertical edge of the said plate 88 or vertical rear wall of the piece of furniture. The lateral wall 86 has holes 89 for screws or fastening bolts.

A rotary stand 4 with a controlled electric drive of the carrying column 90 bidirectional rotary movement is seated in the holder 83. The carrying column 90 is seated rotationally against the fixed support 81, in a position perpendicular to the base plane P. The screen 85 is mounted on the carrying column 90 with carrying arms 91 and a beam 92. The holder 83 may be alternatively equipped with a non-motorized stand 84 and then the column 90 with the secured screen 85 is rotated manually. The stand 84 is seated on an internal shelf 93 of the holder 83.

The electronic module 94 is placed between the support 81 walls 82. Basically, this module is an amplifier connected to additional loudspeakers 95 of the TV set. The main switch 97 and a socket for a recorder and player 98 are situated in the electronic module 94 cover 96. At the same time this socket may be a docking and power supply station for the said piece of equipment 98. Power supply and transmission wires of all equipment of the support are lead between the support 81 walls 82 and inside the tubular carrying column 90.

FIG. 12 illustrates an extension piece for mounting the mounting support for the TV. Customers may wish to mount the TV support on furniture pieces of various depths or may wish to position the TV screen more forward or more rearwardly with respect to the piece of furniture to which the mounting support is attached. Accordingly, extension piece 101 may be provided and the lateral walls 86 could be integrally formed or be secured to extension piece 101. Accordingly, spatial angular support 81 and holder 83 can move retractably back and forth inside extension piece 101.

In the alternative, spatial angular support 81 may be attached to the top of extension piece 101 and may be retractably moved back and forth on top of extension piece 101 as required by the viewer for the particular furniture piece depth, the desired maximum rotation angle of the television, and other such considerations.

Inside extension piece 101 may be a track or a couple of set parallel tracks on which spatial angular support 81 moves. In addition, both the top and bottom inside portions of extension piece 101 may have one or more such tracks on which spatial angular support 81 moves or the lateral inside walls of extension piece 101 may have the tracks. In the alternative, extension piece 101 may have one or more protruding guide lips positioned as above-described with respect to the tracks, and the spatial angular support 81 may have the track or tracks for mating with the grooves of extension piece 101.

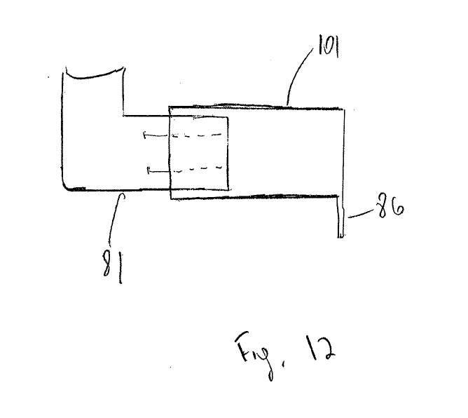

FIG. 13 illustrates bottom sleeve 110 configured to receive lateral wall 86 of the mounting support. It may be the case that the back of the furniture piece on which the stand is situated may not be suitable for drilling holes for screws or the user may wish not to drill holes there or this surface may be a glass surface or other subservice which makes drilling screw holes difficult, and thus the user may wish to drill holes on the bottom of the furniture piece. Also, the side of the furniture piece or table may be too thin for drilling the screw holes and thus the customer may wish to attach the support to the bottom of the furniture. Accordingly, bottom sleeve 110 receives lateral wall 86 inside recess 111 and lateral wall 86 may be secured to bottom sleeve via screws 112. Then, the entire bottom sleeve 110 may be attached to the bottom of the furniture piece using screws 113.

In the alternative, bottom sleeve 110 may be attached to the bottom of the furniture piece using clamps 114 instead of screws 113 so as to obviate the need to drill on the bottom of the furniture piece. Clamp 114 may have hard rubber piece for attaching to the bottom of the furniture piece. Such an application may be particularly advantageous when the furniture piece is glass, porcelain or other type of materials where drilling is impossible, difficult or risks damage to the furniture piece.

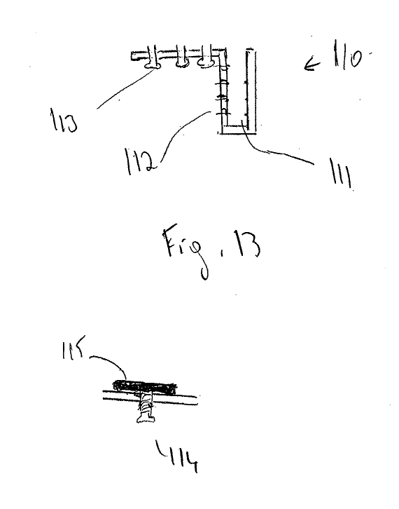

FIG. 14 illustrates rubber pad 120 mounted on the bottom of spatial angular support 81. Rubber pad 120 can be chosen so as to provide a high coefficient of friction and thus to prevent sliding of the support on the furniture piece which is mounted. Such sliding can damage the TV, upset the degree of rotation of the TV and the viewing angle, and can damage the surface of the furniture piece. In addition, rubber pad 120 can prevent damage by screws positioned at lateral wall 86 by shifting in the screw holes in which they are mounted thus preventing undue torque of the screws.

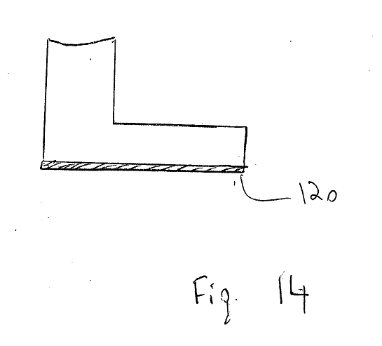

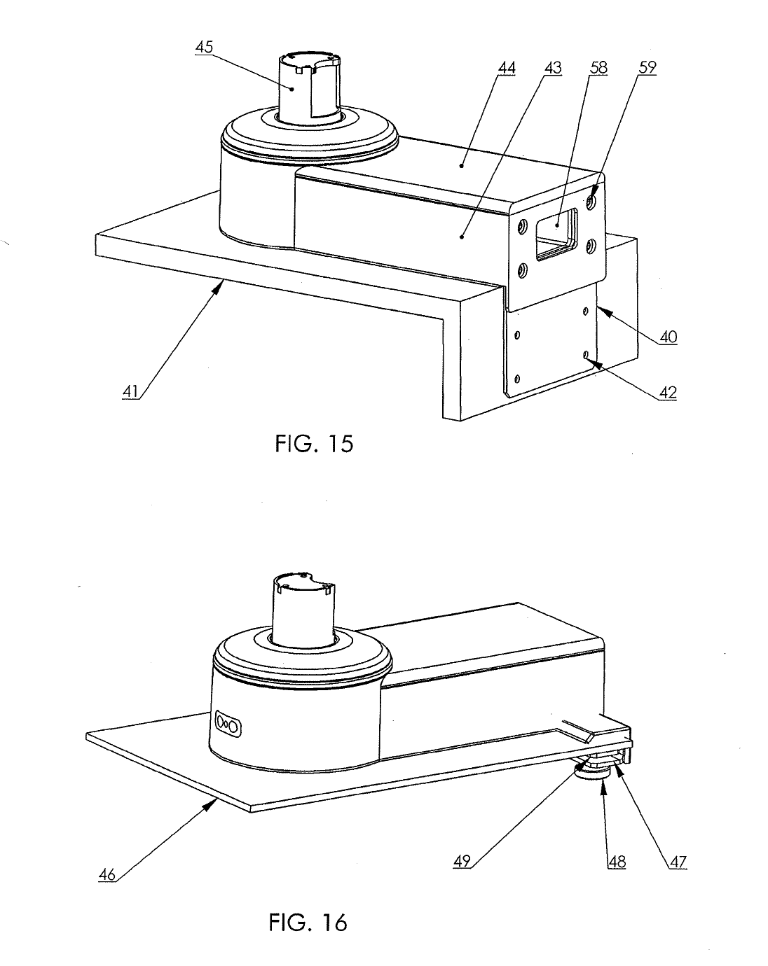

Also shown is a stand for a large TV with a stand of special stiffness steel construction. FIGS. 15-20 show several embodiments of these features.

FIG. 15 illustrates standard furniture mounting to a furniture panel 41 top and back with sufficient strength. Furniture mounting metal plate 40 with existing mounting holes 42 is directly fixed to carrying steel construction 58 with mounting screws 59. Carrying steel construction 58 is encased with decorating cover 43 and closed from top side with top decorating cover 44. Rotation device 45 is directly assembled to carrying steel construction 58 with supplied screws.

FIG. 16 illustrates a glass mounting method. Glass mounting metal plate 47 with already mounted two handwheel 48 and pressure plate 49 is provided. All these parts can be provided as an integrated element able to hold glass 46 with sufficient strength.

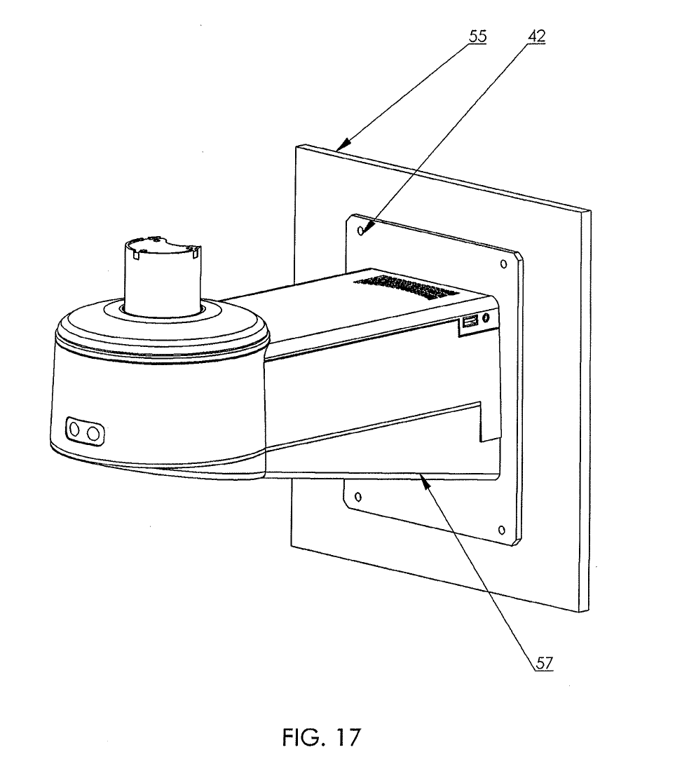

FIG. 17 shows a wall mounting solution. Carrying steel construction 58 is directly mounted to carrying wall construction 58 and fixed through mounting holes 42 to wall 55 with mounting screws 59.

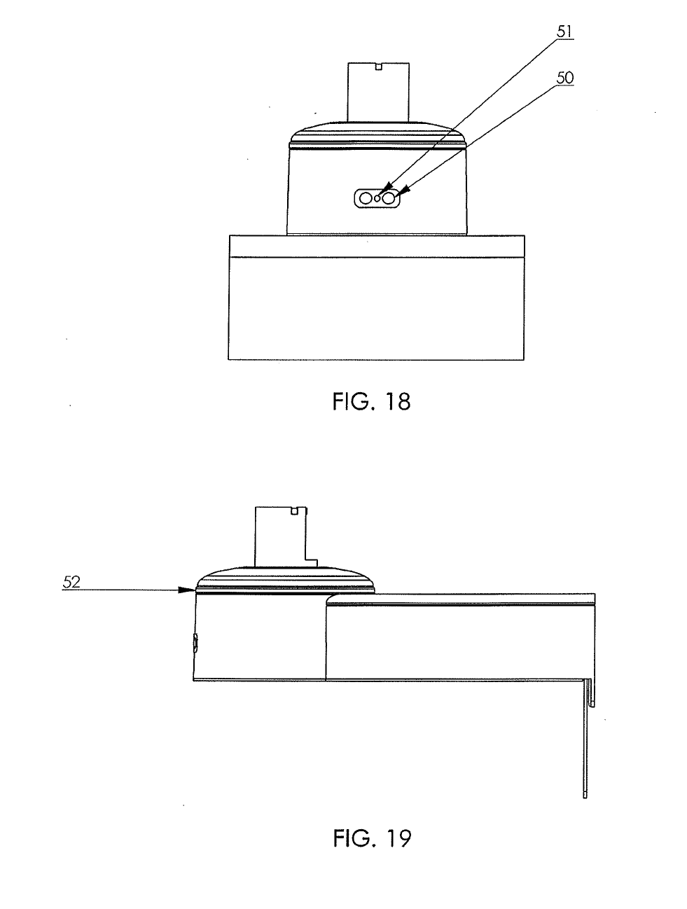

FIG. 18 shows a control panel with volume buttons 50 and IR receiver eye 51. Panel may be integrated with internal electronic devices and control their functions.

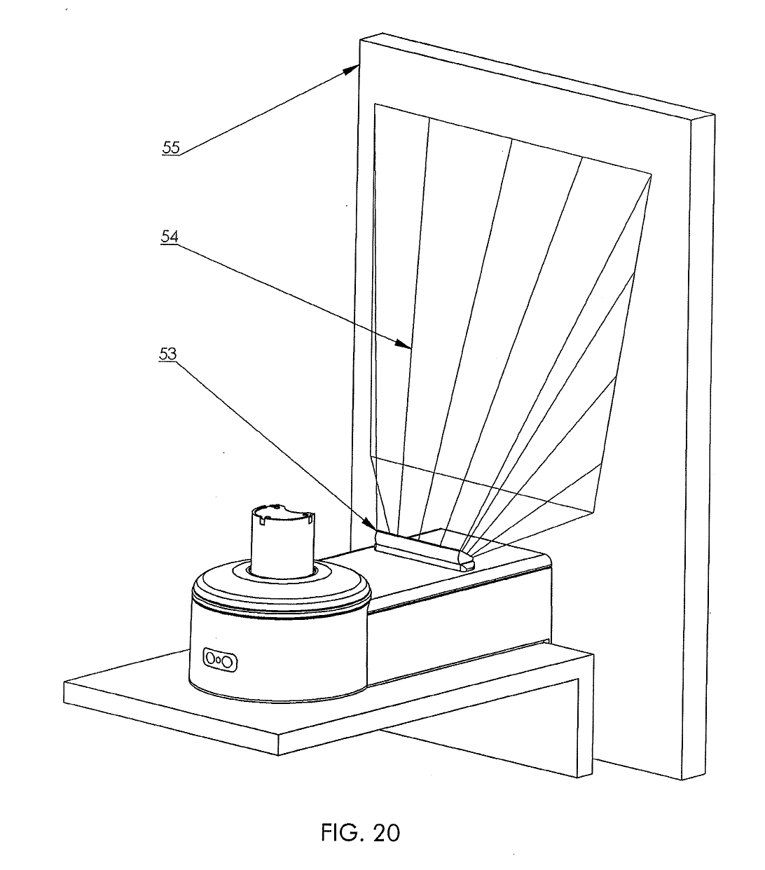

FIG. 19 illustrates lightning ring 52, which functionally is an optical wave guide for user lightning communication states. Light can be permanent or intermittent regarding to rotation mechanical running function.

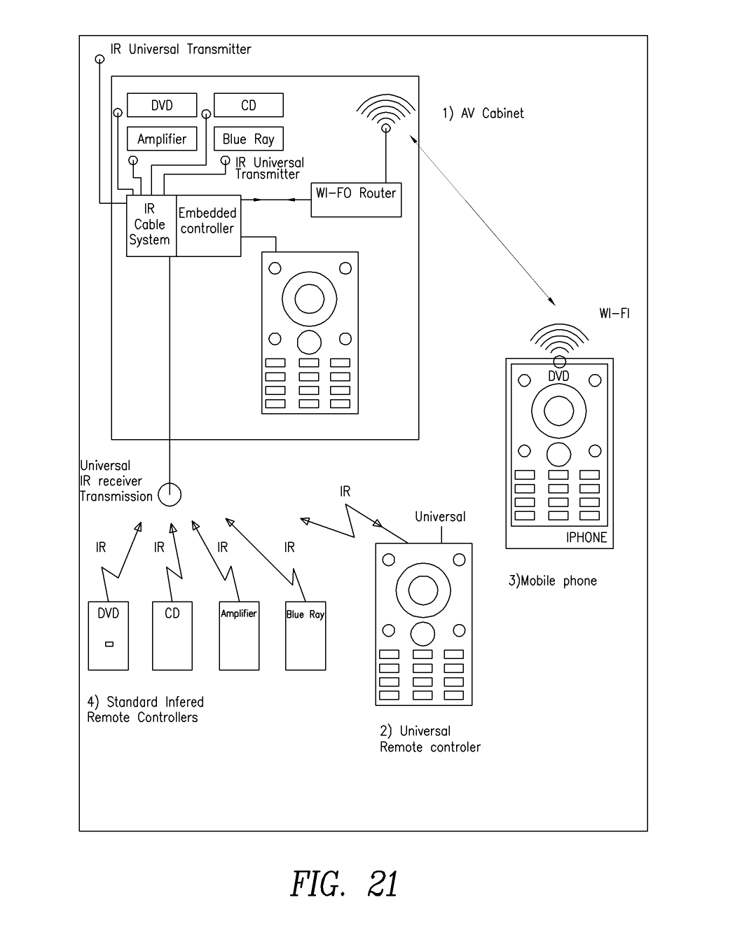

FIG. 20 illustrates a complete TV stand a with rotation device that may be equipped with background tilting light 53 to illuminate back TV area and wall at the back of TV. Drawing shows lightning sheaf 54 principle of operation.

Although the present application is described and shown in relation to particular embodiments thereof, many other variations and modifications and other uses will become apparent to those skilled in the art. Thus, various embodiments and variations are shown and described herein, and it is preferred, therefore, that the present application be limited not by the specific disclosure herein.

What is claimed is:

1. A remote control device configured to communicate wirelessly for controlling a position or orientation of a stand that supports a visual display.

2. The remote control device of claim 1, wherein the remote control device includes preset settings, each setting for controlling a rotation of the stand so as to rotate the visual display to a previously defined point of rotation.

3. The remote control device of claim 1, further comprising a lighting strip positioned at the stand, the lighting strip configured to activate lights of the lighting strip to indicate a position of the visual display.

4. The remote control device of claim 1, further comprising a lighting strip positioned at the stand, the lighting strip configured to activate lights of the lighting strip to indicate a direction of rotation of the visual display.

5. The remote control device of claim 1 in combination with the stand comprising a TV screen or monitor support, the TV screen or monitor support comprising:
a base including a fastening member and a horizontally extending base body having a flat bottom surface configured to rest on a flat furniture surface, said base body having a supporting end and a fastening end;
a turning mechanism located at the supporting end of the base body, said turning mechanism including a holder for holding said TV screen or monitor;
said fastening member extending substantially perpendicularly from said fastening end of said base body; and
said fastening member being configured to enable said base body to be immovably and securely secured to a furniture item.

6. The support of claim 5, wherein the turning mechanism includes an electrical drive of bi-directional rotary movement, seated rotationally on the base body, perpendicularly to the flat bottom of the base body.

7. The support of claim 5, wherein the fastening member includes a clamping mechanism with a clamp for clamping the support to a table or furniture top by clamping of said furniture top between said bottom surface of the base and the clamp.

8. The support of claim 5, further comprising a high co-efficient material attached to the bottom surface of the base body so as to prevent movement of the base body on a support surface of the furniture item on which it has been located.

9. The support of claim 8, wherein said material comprises rubber.

10. The support of claim 5, wherein said fastening member includes a horizontally extending slide that is configured to slide within said base body in order to enable adjusting the distance between said supporting end and said fastening member.

11. The support of claim 5, wherein said turning mechanism includes a motor and bi-directional rotation circuit therefor, said bi-directional rotation circuit including a potentiometer for enabling electrical adjustment of a maximum angular position, a bearing surface coupled with said potentiometer, a friction clutch comprising a component of a kinematic drive chain transferring torque from an electrical drive to said bearing surface.

12. The remote control device of claim 1 in combination with the stand, the stand comprising:
a rotary stand for a TV screen or monitor, which require an adjustable angular position relative to its vertical axis, comprising:
a holder in a bearing column, mounted rotationally in a fixed mount, fitted with a controlled electric drive of the bearing column bi-directional rotation;
a potentiometer for electric adjustment of the bearing column angular position, said potentiometer being directly coupled with the bearing surface; and
a friction clutch, as a component of a kinematic drive chain, transferring torque from the electric drive to the bearing column.

13. The rotary TV stand as claimed in claim 12, wherein a component of the potentiometer is coupled with the bearing surface and comprises a ring with a slide attached thereto.

14. The rotary TV stand as claimed in claim 12, including a disk for the potentiometer with resistance paths fixed stationary in a mount, concentrically with the ring of the potentiometer.

15. The rotary TV stand as claimed in claim 12, wherein a kinematic driving chain, constituting a power unit comprises an electric drive, a friction clutch and a main gear.

16. The rotary TV stand as claimed in claim 12, including a driven wheel of a main drive being fixed stationary and concentrically on the bearing column.

17. The rotary TV stand as claimed in claim 12, including a programmable control system enabling limiting angular positions of the screen secured in a holder on the bearing column to be automatically set and programmed.

18. The rotary TV stand as claimed in claim 13, wherein the control system software contains a function of storing selected angular positions of the bearing column.
